(19) United States
(12) Patent Application Publication
(10) Pub. No.: US 2018/0261375 A1
(43) Pub. Date: Sep. 13, 2018

(54) MAGNETIC CORE CAPABLE OF PREVENTING FAST DC SATURATION ATTENUATION AND MANUFACTURING METHOD THEREOF

(71) Applicant: INNOTRANS TECHNOLOGY CO., LTD., Taipei (TW)

(72) Inventor: Tsung-Han CHOU, Keelung (TW)

(21) Appl. No.: 15/456,087

(22) Filed: Mar. 10, 2017

(51) Int. Cl. H01F 27/26; H01F 41/02

(52) U.S. Cl. CPC H01F 27/263; H01F 41/0246

(57) ABSTRACT

A magnetic core capable of preventing fast direct current (DC) saturation attenuation is a sintered integral, and includes a center column, two side columns and a base. Each side column is disposed at a distance from the center column and is parallel to the center column. The base is connected to the center column and the side columns. The center column has a first magnetic permeability, and the side columns have a second magnetic permeability that is greater than the first magnetic permeability. The base includes a first connecting portion connected to the center column, two second connecting portions respectively corresponding to the side columns, and two first wing portions extended from the first connecting portion and respectively connected to the second connecting portions. The first connecting portion and the first wing portions have the first magnetic permeability, and the second connecting portions have the second magnetic permeability.

### FIELD OF THE INVENTION

The present invention relates to a magnetic core capable of preventing fast direct current (DC) saturation attenuation and a manufacturing method thereof, and particularly to a magnetic core formed as a sintered integral comprising a center column having a lower magnetic permeability and a manufacturing method thereof.

### BACKGROUND OF THE INVENTION

In many applications, an inductor needs to receive a relatively high direct current (DC), e.g., a 10 A current. In addition to a high DC current, an inductor may also need to operate at a high operating frequency. However, an inductor is formed by a coil of at least one turn, and a magnetic core (or referred to as an iron magnetic core) that generally has one single magnetic permeability. When the inductor is employed in a high DC current application, once the magnetic core becomes saturated, the overall performance of the inductor may attenuate to result a negative effect in the application.

Therefore, a power inductor for reducing the saturation of a DC current is disclosed. For example, the Taiwan Patent Publication No. 1333220 discloses a power inductor. In one embodiment of the above disclosure, the power inductor includes a first magnetic core and a second magnetic core. The second magnetic core has a lower magnetic permeability than that of the first magnetic core, so as to achieve the object of reducing the DC current saturation. However, from the disclosure of paragraphs 3 to 4 on page 14 of the specification, it is learned that the first magnetic core and the second magnetic core, instead of being integrally formed by sintering, are first separately manufactured and then connected. Further, such connection undesirably affects the overall structural strength and characteristics of the overall structure.

### SUMMARY OF THE INVENTION

It is an object of the present invention to solve the issue of fast attenuation when the current reaches saturation for a conventional magnetic core in overall having only one magnetic permeability after the magnetic core is sintered.

To achieve the above object, the present invention provides a magnetic core capable of preventing fast direct current (DC) saturation attenuation. The magnetic core is a sintered integral, and includes a center column, two side columns and a base. Each of the side columns is disposed at a distance from the center column, and is parallel to the center column. The base is connected to the center column and the two side columns. The center column has a first magnetic permeability, and the two side columns have a second magnetic permeability, with the first magnetic permeability being smaller than the second magnetic permeability. The base includes a first connecting portion connected to the center column, two second connecting portions respectively connected to the side columns, and two first wing portions extended from the first connecting portion and respectively connected to the second connecting portions. The first connecting portion and the first wing portions have the first magnetic permeability, and the second connecting portions have the second magnetic permeability.

In one embodiment, the base includes two second wing portions respectively extended from the two side columns and respectively connected to the first wing portions. The two second wing portions have the second magnetic permeability.

The present invention further provides a method for manufacturing a magnetic core capable of preventing fast DC saturation attenuation. The method includes following steps.

In an initialization step, a mold including a mold cavity is provided, a first feeding opening is disposed at a center column forming portion of the mold cavity, and a second feeding opening is formed at each of two side column forming portions in the mold cavity.

In a feeding step, a material is fed into the mold cavity through the first feeding opening and the second feeding openings, such that a first magnetic material is fed to the center column forming portion through the first feeding and a second magnetic material is fed to the side column forming portions through the respective second feeding openings. Further, the first magnetic material fed in is contact with the second magnetic material in the mold cavity, and the first magnetic material and the second magnetic material are the same material, with however the magnetic permeability of the first magnetic material being smaller than the magnetic permeability of the second magnetic material.

In a sintering step, a sintering process is performed on the mold, to cause the first magnetic material and the second magnetic material fed into the mold cavity to be integrally sintered into the magnetic core. The magnetic core includes the center column formed by the first magnetic material, the two side columns formed by the second magnetic material, and the base. The base is connected to the center column and the two side columns. The center column has the first magnetic permeability, and the two side columns have the second magnetic permeability, with the first magnetic permeability being smaller than the second magnetic permeability. The base includes the first connecting portion connected to the center column, the two second connecting portions respectively corresponding to the two side columns, and the two first wing portions extended from the first connecting portion and respectively connected to the two second connecting portions. The first connecting portion and the first wing portions have the first magnetic permeability, and the second connecting portions have the second magnetic permeability.

In one embodiment, in the sintering step, the base includes two second wing portions respectively extended from the side columns and respectively connected to the first wing portions. The second wing portions have the second magnetic permeability.

In one embodiment, the first magnetic material and the second magnetic material are ferrites.

Through the embodiments of the present invention, the magnetic core of the present invention provides following features compared to a conventional solution. The magnetic core is an integral formed by sintering, and has a first magnetic permeability and a second magnetic permeability. Compared to a conventional solution, the present invention is capable of preventing fast DC saturation attenuation. Further, in addition to forming the center column of the magnetic core of the present invention by the first magnetic material, the first magnetic material is further used to form the first connecting portion and the two first wing portions of the base, thereby preventing breakage of the center column of the magnetic core after the sintering process.

### BRIEF DESCRIPTION OF THE DRAWINGS

FIG. 1 is a perspective schematic diagram of a magnetic core according to an embodiment of the present invention;

FIG. 2 is a section schematic diagram of a magnetic core according to an embodiment of the present invention;

FIG. 3 is a section schematic diagram of a magnetic core according to another embodiment of the present invention;

FIG. 4 is a perspective schematic diagram of a magnetic core according to another embodiment of the present invention;

FIG. 5 is a section schematic diagram of a magnetic core according to another embodiment of the present invention;

FIG. 6 is a flowchart of a manufacturing method according to an embodiment of the present invention;

FIG. 7 is a schematic diagram of a mold according to an embodiment of the present invention;

FIG. 8 is a schematic diagram of a mold without a material fed therein according to an embodiment of the present invention;

FIG. 9 is a schematic diagram of a mold with a material fed therein according to an embodiment of the present invention;

FIG. 10 is a schematic diagram of a mold with a material fed therein according to another embodiment of the present invention; and

FIG. 11 is a comparison diagram of characteristics of an experiment of the present invention.

### DETAILED DESCRIPTION OF THE PREFERRED EMBODIMENTS

Details and technical contents of the present invention are given with the accompanying drawings below.

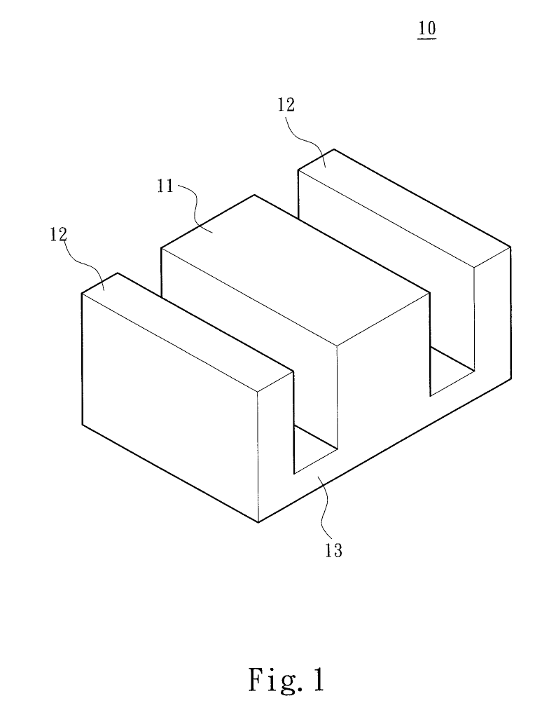

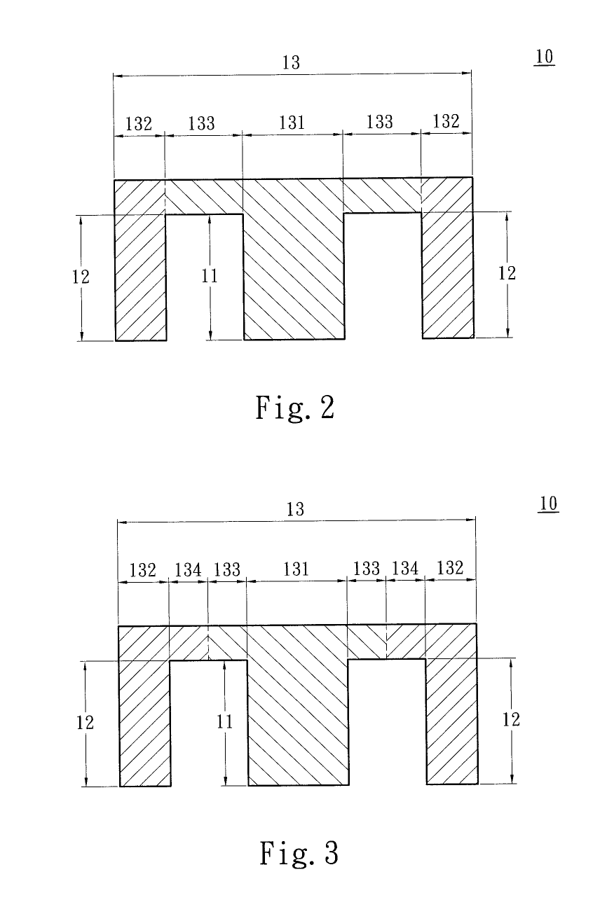

Referring to FIG. 1 and FIG. 2, the present invention provides a magnetic core 10 capable of preventing fast direct current (DC) saturation attenuation. The magnetic core is formed by a one-time sintering process. That is to say, the magnetic core 10 is a sintered integral. The magnetic core 10 includes a center column 11, two side columns 12 and a base 13. Each of the side columns 12 is disposed at a distance from the center column 11, and is parallel to the center column 11. The base 13 is connected to the center column 11 and the two side columns 12. The center column 11 of the present invention has a first magnetic permeability, and the two side columns 12 have a second magnetic permeability smaller than the first magnetic permeability. The base 13 includes a first connecting portion 131 connected to the center column 11, two second connecting portions 132 respectively corresponding to the side columns 12, and two first wing portions 133 extended from the first connecting portion 131 and respectively connect to the second connecting portions 132. The first connecting portion 131 and the first wing portions 133 have the first magnetic permeability, and the second connecting portions 132 have the second magnetic permeability. Referring to FIG. 3, in one embodiment, the base 13 includes two second wing portions 134 respectively extended from the two side columns 12 and respectively connected to the first wing portions 133. The second wing portions 134 have the second magnetic permeability. More specifically, the ratio of lengths of the first wing portions 133 and the second wing portions 134 may be modified based on actual application requirements, and is not limited to the ratio depicted in the drawings of the application.

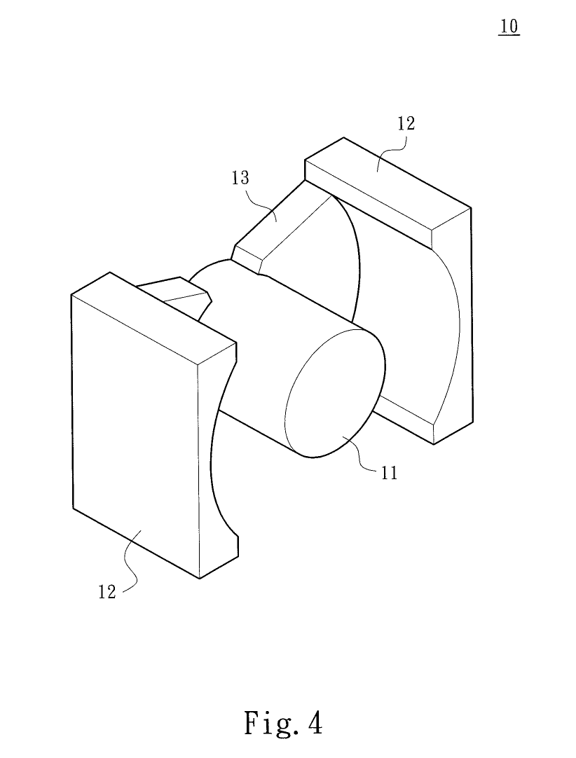

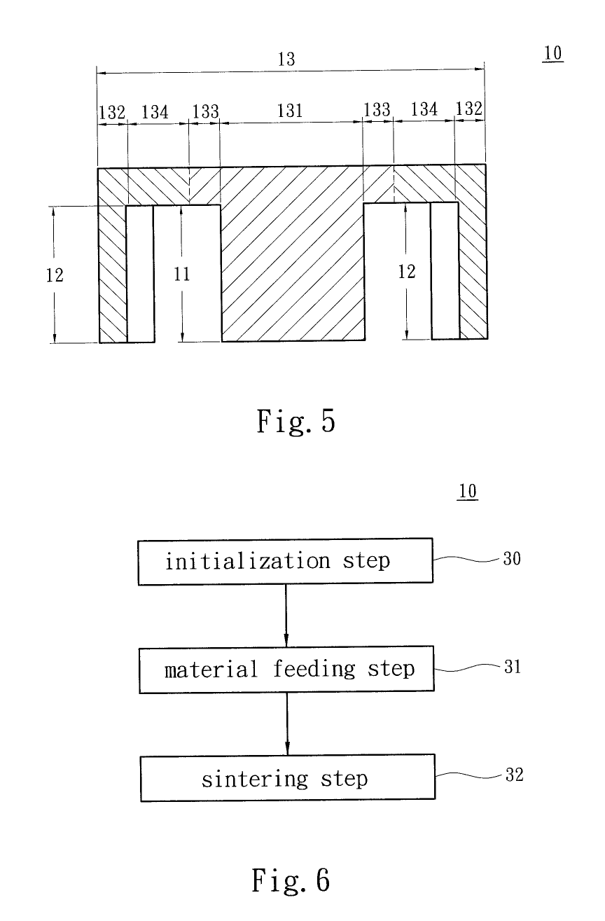

In addition to an E-type magnetic core, the magnetic core 10 of the present invention may also be implemented by a PQ-type magnetic core, as shown in FIG. 4 and FIG. 5.

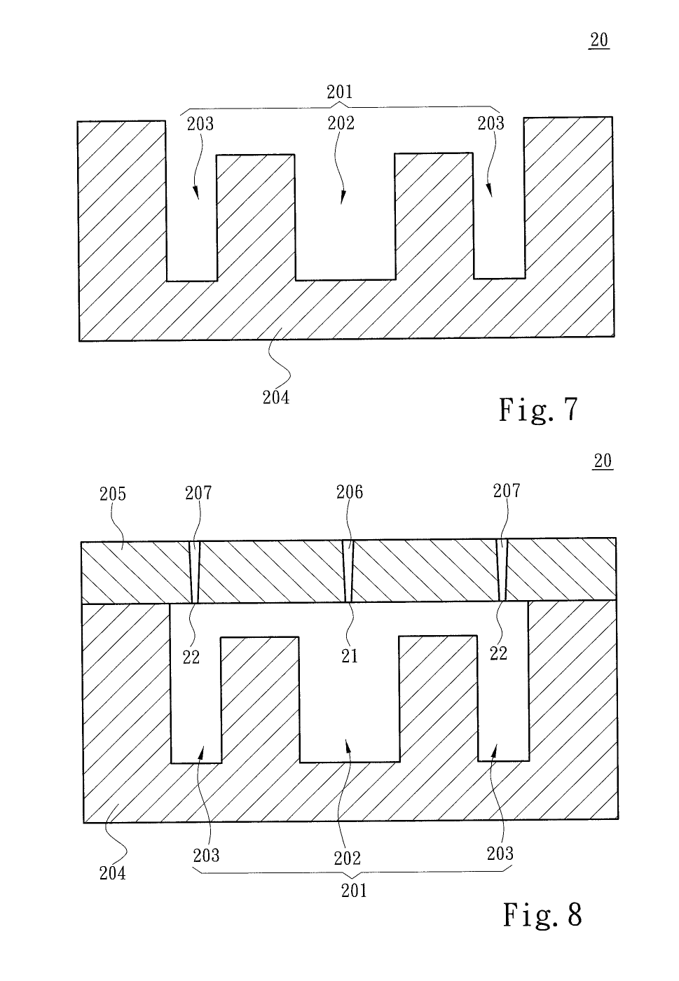

Referring to FIG. 6 to FIG. 9, the present invention further provides a method for manufacturing a magnetic core capable of preventing fast DC saturation attenuation. The method is performed in coordination with a mold 20, and includes following steps.

In an initialization step 30, the mold 20 including a mold cavity 201 is provided, a first feeding opening 21 is disposed at a center column forming portion 202 in the mold cavity 201, and a second feeding opening 22 is disposed at each of two side column forming portions 203 in the mold cavity 201.

In a feeding step 31, a material is fed into the mold cavity 201 through the first feeding opening 21 and the second feeding openings 22, such that a first magnetic material 40 is fed to the center column forming portion 202 through the first feeding opening 21 and a second magnetic material 41 is fed to the side column forming portions 203 through the respective second feeding openings 22. Further, the first magnetic material 40 fed in is contact with the second magnetic material 41 in the mold cavity 201, and the first magnetic material 40 and the second magnetic material 41 are the same material, with however the magnetic permeability of the first magnetic material 40 being smaller than the magnetic permeability of the second magnetic material 41.

In a sintering step 32, a sintering process is performed on the mold 20, to cause the first magnetic material 40 and the second magnetic material 41 fed into the mold cavity 201 to be integrally sintered into the magnetic core 10. The magnetic core 10 includes the center column 11 formed by the first magnetic material 40, the two side columns 12 formed by the second magnetic material 41, and the base 13. The base 13 is connected to the center column 11 and the two side columns 12. The center column 11 has the first magnetic permeability, and the two side columns 12 have the second magnetic permeability, with the first magnetic permeability being smaller than the second magnetic permeability. The base 13 includes the first connecting portion 131 connected to the center column 11, the two second connecting portions 132 respectively corresponding to the two side columns 12, and the two first wing portions 133 extended from the first connecting portion 131 and respectively connected to the two second connecting portions 132. The first connecting portion 131 and the first wing portions 133 have the first magnetic permeability, and the second connecting portions 132 have the second magnetic permeability.

More specifically, in one embodiment of the present invention, the mold 20 may be divided into a lower mold body 204 and an upper mold body 205. The lower mold body 204 includes the mold cavity 201, and the upper mold body 205 includes the first feeding opening 21 and the two second feeding openings 22 corresponding to the mold cavity 201. Further, the first feeding opening 21 is connected to a first feeding channel 206, and each of the second feeding openings 22 is connected to a second feeding channel 207. In the present invention, each of the first feeding channel 206 and the two second feeding channels 207 is connected to a feed control module (not shown), and the material is provided through one of the feed control modules connected. More specifically, one of the feed control modules connected to the first feeding channel 206 provides the first feeding channel 206 with the first magnetic material 40, and another feed control module connected to the second feeding channel 207 provides the second feeding channel 207 with the second magnetic material 41. Further, details of the control of the feed control modules are generally known to one person skilled in the art, and shall be omitted herein. In one embodiment, the first magnetic material 40 and the second magnetic material 41 are ferrite powder, with however the magnetic permeabilities of the two being different.

In continuation, in the feeding step 31 of the method, the upper mold body 205 is correspondingly stacked on the lower mold body 204, and the material is fed into the mold cavity 201 through the first feeding opening 21 and the second feeding opening 22. That is to say, the material control modules provide the material to the first feeding channel 206 and the second feeding channels 207, respectively. At this point, the first magnetic material 40 is fed to the center column forming portion 202 of the mold cavity 201 through the first feeding opening 21, and the second magnetic material 41 is fed to the two side column forming portions 203 in the mold cavity 201 through two second feeding channels 22. When the material fed satisfies a predetermined condition, the feeding process is terminated, and the sintering step 32 is then performed. In the sintering step 32, the mold 20 is heated or pressurized to perform sintering, to cause the first magnetic material 40 and the second magnetic material 41 in the mold cavity 201 to be integrally sintered into the magnetic core 10. A mold removal process is next performed.

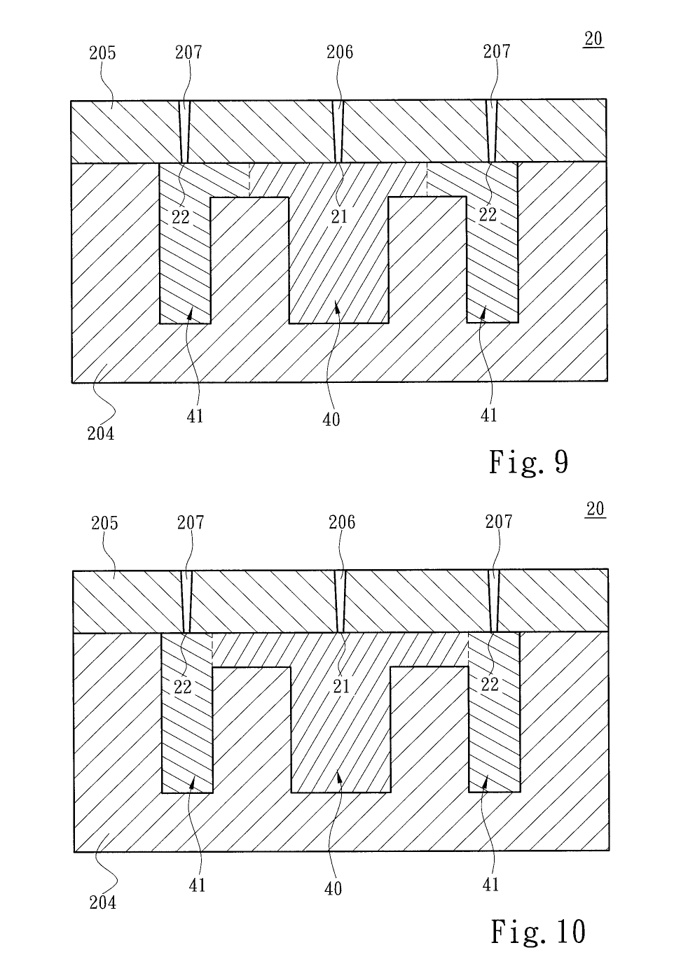

In one embodiment, in the sintering step 32, feeding parameters of these feed control modules may be controlled, in a way that, in addition to being fed to the center column forming portion 202 or the two side column forming portions 203, the first magnetic material 40 and the second magnetic material 41 are further overflowed to the part of the mold cavity 201 where the base 13 is to be formed, as shown in FIG. 10. Thus, after the sintering process, the magnetic core 10 includes the two first wing portions 133 and the two second wing portions 134, as shown in FIG. 3. The first wing portions 133 have the first magnetic permeability, and the second wing portions 134 have the second magnetic permeability.

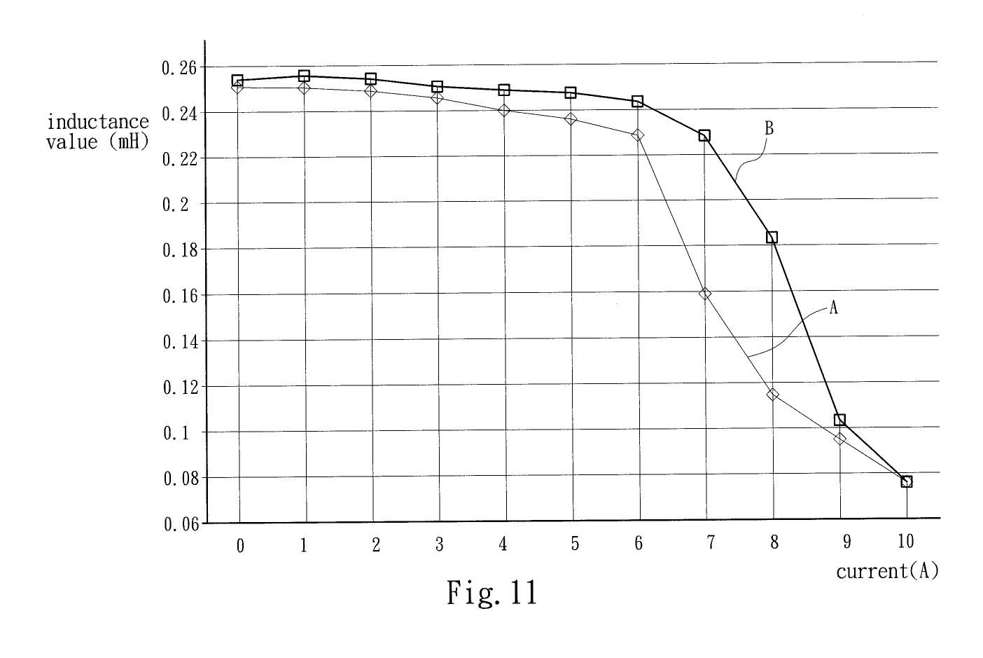

In one comparison experiment, a ferrite KP44A is implemented as a conventional magnetic core to be compared with the magnetic core 10 disclosed by the present invention. In the magnetic core 10 of the present invention, the first magnetic material 40 is implemented by a ferrite KP50 and the second magnetic material 41 is implemented by a ferrite KP44A. Further, each of the conventional magnetic core and the magnetic core 10 of the present invention is made into an inductor using the same winding parameter, a power test using a fixed voltage (1V) and a constant frequency (100 kHz) is performed, and the current (I) is gradually increased during the power test. FIG. 11 shows related test reports. As seen from FIG. 11, when the conventional magnetic core (denoted as A in FIG. 11) and the magnetic core 10 of the present invention (denoted as B in FIG. 11) receive a current that is greater than 6 A, the inductance value drastically drops as the conventional magnetic core enters DC saturation. In contrast, when the current applied on the magnetic core 10 of the present invention reaches 6 A, although attenuation similarly occurs, the level of attenuation is apparently slower and more moderate than that of the conventional magnetic core. Therefore, compared to the conventional magnetic core, the magnetic core 10 of the present invention is capable of preventing fast attenuation caused by DC saturation.

What is claimed is:

1. A magnetic core capable of preventing fast direct current (DC) saturation attenuation, the magnetic core being a sintered integral comprising a center column, two side columns and a base, each of the side columns disposed at a distance from the center column and being parallel to the center column, the base being connected to the center column and the two side columns, the magnetic core being characterized that:
the center column has a first magnetic permeability, the two side columns respectively have a second magnetic permeability, the first magnetic permeability is smaller than the second magnetic permeability, the base comprises a first connecting portion connected to the center column, two second connecting portions respectively corresponding to the side columns, and two first wing portions extended from the first connecting portion and respectively connected to the second connecting portions, the first connecting portion and the first wing portions have the first magnetic permeability, and the second connecting portions have the second magnetic permeability.

2. The magnetic core capable of preventing fast DC saturation attenuation of claim 1, being characterized that, the base further comprises two second wing portions respectively extended from the side columns and respectively connected to the first wing portions, and the second wing portions have the second magnetic permeability.

3. A method for manufacturing a magnetic core capable of preventing fast direct current (DC) saturation attenuation, comprising:
an initialization step of providing a mold comprising a mold cavity, disposing a first feeding opening at a center column forming portion in the mold cavity, and disposing a second feeding opening at each of two side column forming portions in the mold cavity;
a feeding step of feeding a material into the mold cavity through the first feeding opening and the second feeding openings, such that a first magnetic material is fed to the center column forming portion through the first feeding opening and a second magnetic material is fed to the side column forming portions though the respective second feeding openings, wherein the first magnetic material fed in is contact with the second magnetic material in the mold cavity, the first magnetic material and the second magnetic material are a same material, and the magnetic permeability of the first magnetic material is smaller than that of the second magnetic material; and
a sintering step of sintering the mold to cause the first magnetic material and the second magnetic material fed in the mold cavity to be integrally sintered into a magnetic core, wherein the magnetic core comprises a center column formed by the first magnetic material, two side columns formed by the second magnetic material and a base, the base is connected to the center column and the two side columns, the center column has a first magnetic permeability, the two side columns have a second magnetic permeability, the second magnetic permeability is smaller than the first magnetic permeability, the base comprises a first connecting portion connected to the center column, two second connecting portions respectively corresponding to the side columns, and two first wing portions extended from the first connecting portion and respectively connected to the second connecting portions, the first connecting portion and the first wing portions have the first magnetic permeability, and the second connecting portions have the second magnetic permeability.

4. The method for manufacturing a magnetic core capable of preventing fast DC saturation attenuation according to claim 3, being characterized that, in the sintering step, the base comprises two second wing portions respectively extended from the side columns and respectively connected to the first wing portions, and the second wing portions have the second magnetic permeability.

5. The method for manufacturing a magnetic core capable of preventing fast DC saturation attenuation according to claim 3, being characterized that, each of the first magnetic material and the second magnetic material is a ferrite.

6. The method for manufacturing a magnetic core capable of preventing fast DC saturation attenuation according to claim 5, being characterized that, in the sintering step, the base comprises two second wing portions respectively extended from the side columns and respectively connected to the first wing portions, and the second wing portions have the second magnetic permeability.
